(19) United States
(12) Patent Application Publication
(10) Pub. No.: US 2011/0206875 A1
(43) Pub. Date: Aug. 25, 2011

(54) METHOD AND ARRANGEMENT FOR PRODUCTION OF AN INTEGRAL HOLLOW-PROFILED COMPONENT WITH FIBRE COMPOSITE MATERIAL

(76) Inventor: Ralf Kohlen, Unterhaching (DE)

(21) Appl. No.: 13/030,764

(22) Filed: Feb. 18, 2011

(30) Foreign Application Priority Data
Feb. 19, 2010 (DE) 102010008711.4

(51) Int. Cl. B28B 21/48; B29C 41/42; B32B 1/00; B29C 41/46; B29C 65/56

(52) U.S. Cl. 428/34.1; 264/334; 425/470; 264/319; 29/527.1

(57) ABSTRACT

Method for production of an integral hollow-profiled component with fibre composite material comprising at least the following steps: a) providing at least one inner tool core, b) covering the at least one inner tool core with at least one layer of fibre composite material, c) curing the at least one layer of fibre composite material, and d) removing the at least one inner tool core. This makes it possible to produce particularly dimensionally accurate aircraft components, which have an integral hollow-profiled component with a tapering cross section and a plurality of longitudinally running stringers.

### CROSS-REFERENCE TO RELATED APPLICATIONS

This application claims priority to German patent application no. 102010008711.4 filed Feb. 19, 2010, the entire contents of which are incorporated by reference as if set forth in its entirety herein.

### STATEMENT CONCERNING FEDERALLY SPONSORED RESEARCH OR DEVELOPMENT

Not applicable.

### FIELD OF THE INVENTION

The present invention relates to a method and an arrangement for production of an integral hollow-profiled component with fibre composite material, such as an aircraft component. An aircraft component can be a flow surface which, for example, is part of an aerofoil, of a tailplane or the like.

### BACKGROUND OF THE INVENTION

With respect to the efforts to produce aircraft in the future to be ecologically adapted and to cost little to manufacture, while nevertheless complying with extremely stringent safety regulations, possible ways are increasingly being sought to produce the essential primary structures (for example aerofoil components such as the fin and/or the horizontal stabilizer and/or the aileron) from fibre-reinforced composite material, rather than from aluminium. This lightweight design technology makes it possible, in particular, to considerably reduce the weight of the aircraft. When producing essential primary structures such as these, it is necessary to remember that they assume considerable sizes. For example, the landing flaps or vertical tailplanes of aircraft are components which extend over several metres. Furthermore, these aircraft components are subject to heavy loads, and therefore represent safety-critical components in which particular strength, stiffness and quality requirements must be complied with. Furthermore, it is necessary to remember that these aircraft components may have to have other components fitted to them, as a result of which it is particularly relevant for the aircraft components to comply with the correct dimensions here as well. This relates on the one hand to the outer surfaces of the aircraft component, because these are relevant for the flow behaviour but, furthermore, the inner surfaces must also be manufactured with particular dimensional accuracy because it may be necessary to fit stiffening structures, apparatuses, separating walls or the like in here.

Such fibre-reinforced composite materials are in general composed of two components: fibres and a polymer matrix surrounding the fibres. The polymer matrix surrounds the fibres and is cured, for example, by heat treatment (polymerization), thus resulting in three-dimensional crosslinking. This polymerization results in the fibres being firmly connected to one another. It is also possible to use glass fibres as fibres, in addition to carbon fibres. Carbon fibres, which are nowadays still comparatively expensive, generally consist of at least 90% by weight of carbon. The fibre diameter is, for example, 4.5 to 8 μm [micrometers]. Carbon fibres such as these have anisotropic characteristics. In contrast, glass fibres have an amorphous structure and isotropic characteristics. They are composed predominantly of silicon oxide, although further oxides may possibly be added. While glass fibres are relatively good, carbon fibres are distinguished by their high strength and stiffness.

The so-called prepreg technique is currently used in aircraft construction. In this technology, for example, prepregnated fabrics or other prefabricated textile semi-finished products are impregnated in synthetic resin and are heat treated only until slight solidification occurs (gelling), such that they can be handled in layers. A prepreg material such as this adheres to a small extent and can therefore be arranged well in mould tools and in layers one on top of the other until a desired component shape is formed. When the desired layers or strata of the prepreg material and of the vacuum structure (outer envelope sheath for the vacuum treatment) have been arranged, then they can be (thermally) cured. Nowadays, so-called autoclaves are used to cure these prepreg components, that is to say ovens which are heated, possibly at an increased pressure (up to 10 bar) over a period of hours, until the evacuated components have been cured completely.

Bearing in mind the fact that, in the case of components such as these, the weight on the one hand is generally a primary factor, and the stringent requirements for the load capability of such components cannot be ignored, these large-area components are regularly reinforced by various types of stiffening elements or webs. In aircraft construction, a distinction is drawn between “stringers” and “ribs” in such stiffening elements. “Stringers” generally extend along an inner surface of the component with a stringer height in the range up to 30 mm, and are generally distinguished by a linear profile and are aligned parallel to one another. In this case, these “stringers” extend in a preferred extent direction of the component over the entire area and project (only) into the internal area. Furthermore, even larger, so-called “ribs”, are generally arranged at regular intervals, such that, together with the “stringers”, these provide additional internal stiffening for the hollow-profiled component. In this case, such “ribs” cover the cross section of the hollow-profiled component; that is to say they are internally connected to the upper face and the lower face. Generally, the “stringers” and the “ribs” run at right angles to one another, although this is not absolutely essential.

Particularly when such complex flow surfaces are designed with the desired curved outer surface and with the inner surfaces having the stiffened areas, it is necessary in production to ensure that the fibre composite materials can be placed accurately in position, easily, reliably and at low cost. However, this leads to considerable difficulties because the requirements mentioned above have mutually conflicting objectives.

In order to cope with the forces which occur during the use of such aircraft components, it is necessary to provide adequate strength, for which purpose an appropriate number of layers of the prepreg material are used, although this does not reliably ensure the required denting stiffness. For this reason, a greater number of layers, for example about 30 layers, are normally used for relatively large aircraft components, in order to achieve an adequate material thickness of more than 4 mm. Efficient and productive manufacturing processes are required for the application of the multiplicity of layers or strata which in the end, for example, form the outer skin of an aircraft component such as this. One process, which is already in use for the construction of small aircraft components, is the so-called placement “Automated Fibre Placement process” (AFP process), in which an automatically operating fibre laying apparatus having at least one moveable application head applies, for example, a pre-impregnated fibre composite material strip to a working surface of a mould or of a component. For this process to be productive, it is desirable for it also to be possible to use it for relatively complex component geometries.

### SUMMARY OF THE INVENTION

Against this background, the object of the present invention is to at least partially solve the problems described with respect to the prior art. One particular aim is to specify a method for production of an integral hollow-profiled component with fibre composite material, which is suitable for production using an automated placement process (in particular AFP). A further aim is to propose a method and an apparatus for carrying out a method such as this, by means of which (virtually) the finished dimensions are actually achieved in the internal area of the hollow-profiled component. The aim in this case is to make it possible to produce hollow-profiled components which are closed in the circumferential direction, for use of the method, for example, for aircraft tailplane structures, with the stringers already being incorporated in these components. A further aim is to manufacture the internal cross section or the internal contour of the integral hollow-profiled component with dimensional accuracy, thus allowing prefabricated ribs, separating walls or the like to be inserted and fixed retrospectively, such that they fit accurately, in particular by adhesive bonding.

These objects are achieved by a method and by an arrangement for production of an integral hollow-profiled component described below in the specification and claims. It should be noted that the features mentioned individually in the patent claims can be combined with one another in any desired technologically worthwhile manner, and indicate further refinements of the invention. The description, in particular in conjunction with the figures, explains the invention, and indicates additionally exemplary embodiments.

The method according to the invention for production of an integral hollow-profiled component with fibre composite material comprises at least the following steps:
a) providing at least one inner tool core,
b) covering the at least one inner tool core with at least one layer of fibre composite material,
c) curing the at least one layer of fibre composite material, and
d) removing the at least one inner tool core.
   In the proposed method, the steps a) to d) are preferably carried out in this sequence. It is equally possible to carry out at least some of these steps such that they overlap in time, or even in parallel with one another Furthermore, it is also possible for further steps to be carried out in parallel or between these steps.

In particular, the method relates to a production method for an integral hollow-profiled component. “Integral” is intended to mean that the hollow-profiled component has no material interruption all the way through it. The term “hollow profile” is intended to mean that the component that is produced surrounds a cavity, although this does not necessarily mean a cylindrical component. For example, the cross section of this hollow-profiled component may be approximately oval or tear drop-shaped. In the preferred use of this method according to the invention, the hollow-profiled component is the primary structure of a tailplane, in particular of a vertical tailplane. Furthermore, the integral hollow-profiled component may be a component such as this whose walls are formed by fibre composite material. In this case, it may be preferable for the entire integral hollow-profiled component to be produced using the same fibre composite material. The fibre composite material may be provided as a material in the form of strip with a pre-impregnated fibre composite material strip, such as a unidirectional carbon-fibre prepreg strip (UD-CFC prepreg strip). In principle, a dry layer material may also be chosen, which is retrospectively impregnated with the plastic resin. Furthermore, it is also possible to choose a material which is formed from a pre-impregnated fibre strand (roving), in particular a CFC roving.

According to step a), at least one inner tool core is initially provided. In particular, this inner tool core is a tool mould which, for example, comprises a positive mould (mandrel; winding mandrel). This at least one inner tool core is preferably likewise hollow. This hollow configuration of the inner tool core results in an arrangement for carrying out the method which is particularly light in weight and can therefore be handled more easily. Furthermore, this tool is then particularly able to exhibit a deliberate thermal expansion behaviour during subsequent heat treatment of the fibre composite material, thus allowing both dimensional accuracy and the deformability to be achieved by deliberate expansion and shrinkage. It is very particularly preferable for one and only one hollow inner tool core to be used for the production of this integral hollow-profiled component. The at least one inner tool core is preferably composed of metallic material.

According to step b), the at least one inner tool core is now covered by at least one layer of fibre composite material. It is preferable to arrange a multiplicity of layers or strata of fibre composite material around the at least one inner tool core such that the layers or strata at least partially directly cover one another. It is very particularly preferable for the at least one inner tool core to be covered completely with fibre composite material. It is therefore very particularly preferable for the entire tool core to be surrounded by fibre composite material (with the exception of the end faces) after step b).

Step c) now generally results in heat treatment of the fibre composite material, such that the at least one layer of fibre composite material is cured. It is preferable for the curing of the at least one layer of fibre composite material to be carried out in a vacuum (in a vacuum structure) with an increased pressure in the oven. It is furthermore preferable for step c) to be carried out in an autoclave. The curing process for a layer of fibre composite material such as this is well known by those skilled in the art, and there is therefore no need for any further explanation here.

Finally, once the fibre composite material has been cured, the at least one inner tool core can be removed according to step d), as a result of which there is no need for shaping of the cured, integral hollow-profiled component. For this purpose, the at least one inner tool core is designed such that, at the time when step b) is carried out, small contact-pressure forces are provided from the at least one inner tool core towards the hollow-profiled component. This can be achieved, for example, by the at least one inner tool core shrinking after the heat treatment, and/or by forming only linear contact areas towards the hollow-profiled component after step c). This allows the tool and hollow-profiled component to be removed from the mould particularly easily.

The method proposed here allows an integral hollow-profiled component such as this to be manufactured with a predetermined internal contour while complying with very strict dimensional requirements, by the contact with the inner tool core. The configuration of the at least one inner tool core furthermore makes it possible to take account of the thermal response to a temperature change between room temperature and about 180° C. such that, if possible, the internal finished dimensions of the integral hollow-profiled component are virtually achieved at the curing temperature specified here of about 180° C. for the fibre composite material. The process of cooling down to room temperature, and the shrinkage resulting from this of the at least one inner tool core, make it possible to remove the hollow-profiled component and the at least one inner tool core from the mould without deformation of the hollow-profiled component. Integral, closed, hollow-profiled components can therefore be produced, in particular in the circumferential direction, in which it is also possible to retrospectively fit ribs without having to machine the internal hollow-profiled contour or to once again deform the hollow-profiled component. Furthermore, the disclosed method offers the capability to use an automatic fibre placement process, in particular the so-called automated fibre placement process (AFP).

According to one form of the method, between step a) and b) at least one surface segment tool may be positioned on an outer surface of the at least one inner tool core. A surface segment tool such as this may, for example, be designed to be rectangular, in the form of a strip or to have a similar shape. This surface segment tool may be positioned on the surface of the at least one inner tool such that it projects from this surface. It is furthermore preferable for a plurality of such surface segment tools to be positioned approximately parallel to one another, (directly) adjacent to one another and/or in the same cutout in the outer surface of the at least one inner tool core. It is furthermore possible for the surface segment tools to be connected to the at least one inner tool core (detachably), such that a relative position is maintained between the surface segments and the at least one inner tool core at least during steps b) and/or c).

In some forms of the method, the at least one surface segment may be applied with a section of fibre composite material. In other words, a section of fibre composite material may be arranged on the surface segment tool before and/or after the application of the surface segment to the at least one inner tool core. For example, if the surface segment tool is configured in the form of a strip, then the section of fibre composite material can cover one surface and two side surfaces of the surface segment tool completely, as a result of which only a lower base, which makes contact with the outer surface of the at least one inner tool core, is free of the section of fibre composite material, Deviations from this are, of course, possible, for example such that only one side surface and/or only the top surface are/is covered by a section of fibre composite material such as this. The surface segments prepared in this way can be positioned alongside one another, aligned with respect to one another, on the outer surface of the at least one inner tool core, in particular such that the sections of fibre composite material of adjacent surface segments rest directly on one another. These areas, which are arranged between gaps between the plurality of surface segment tools, in the sections of fibre composite material form the so-called stringers, for example, after the curing process. The modular form of the surface segment tools with respect to the outer surface of the at least one inner tool makes it possible to produce different integral hollow-profiled components, in terms of the orientation and configuration of these stringers, by an appropriate choice, number and shape of the surface segment tools.

Step b) may also comprises a winding process. In particular, this means that the at least one inner tool may be covered with a large number of layers composed of one stratum of fibre composite material using, for example, the AFP process. This might be performed using an apparatus for placement of the fibre composite material relative to the at least one inner tool core, and/or the at least one inner tool core might be pivoted or even rotated.

In one form of the method, stringers, which run parallel to one another and are aligned with respect to the at least one inner tool core, may be formed with the at least one layer of fibre composite material. In particular, this can be done by using a plurality of surface segment tools, as described above. This means that fibre composite material is applied to the at least one inner tool core (with the surface segment tools) such that the desired internal contour, close to the finished size dimensions, of the hollow-profiled component is achieved directly after the curing process (step e). There is accordingly no need for retrospective arrangement and attachment of such stringers towards the integral hollow-profiled component.

Furthermore, step d) can be carried out particularly easily in that, in step d), a translational relative movement is carried out between the at least one layer of fibre composite material and the at least one inner tool core. The translational relative movement is carried out, in particular, such that the at least one inner tool core is moved in the direction of the longitudinal extent of the integral hollow-profiled component. Specifically, this means a relative movement which is carried out parallel to the profile of the stringers which face inwards. This relative movement can be assisted by a shrinkage process of the at least one inner tool core being carried out first of all for this step of removal from the mould, such that the contact forces between the at least one inner tool core and the cured hollow-profiled component are relatively small.

Furthermore, it is considered to be advantageous for pressure to be applied externally to the at least one layer of fibre composite material, at least before or during step c). For this purpose, the outermost layer of fibre composite material can also be provided with further sheathing layers, via which (over)pressure is intended to be applied in the course of the curing process. The applied pressure also leads to compliance with the external dimensional accuracy of the hollow-profiled component. The pressure can be provided via a compressible medium and/or a rigid mould part. In this case, it is preferable for the pressure to remain substantially constant during step c).

According to some forms of the method, after step d), at least one rib may be inserted, which covers or spans the cross section of the integral hollow-profiled component. This illustrates one particular advantage of the above described method, because the use of the rib does not require renewed deformation of the hollow-profiled component nor the use of joint components such as rivets, screws, spacers or the like. Because the dimensional compliance of the integral hollow-profiled component is particularly good towards the inside, it is possible to fit prefabricated ribs in easily without any need for special correction measures or additional connecting components. In fact, a connecting joint can be achieved, for example by adhesive bonding, by substantially complete surface contact extending over the entire length of the rib.

The invention is used in particular for an aircraft component which has been produced using the method according to the invention, in which the aircraft component is an integral hollow-profiled component with a tapering cross section and a plurality of longitudinally running stringers. In particular, this aircraft component may be a so-called vertical tailplane (VTP). This integral hollow-profiled component in this case has a tapering cross section, when viewed in the longitudinal direction of the integral hollow-profiled component. In particular, this means a tapered and/or trapezoidal configuration of the hollow-profiled component running in one direction, as a result of which the integral hollow-profiled component forms two (open) end faces of different size. This tapering cross section assists the process of carrying out the method according to the invention as described by making it easier to remove the cured, integral hollow-profiled component from the mould, in that the at least one inner tool core can be removed easily via the end with the larger cross section.

Merely for the sake of completeness, it should be noted that in addition to a vertical tailplane, it is, of course, also possible to produce other flow surfaces of the aircraft or of some other airborne vehicle such as, for example, a large aileron or the like.

According to a further aspect of the invention, an arrangement or apparatus is disclosed for production of integral hollow-profiled components. The arrangement includes at least one inner tool core in the form of a hollow body with an outer surface and a plurality of surface segment tools. The plurality of surface segment tools may be arranged on the outer surface of the at least one inner tool core. In this form, the inner tool core may preferably be a metallic hollow body which has thin walls. A cutout or cutouts are preferably provided on at least one outer surface, and preferably on two opposite outer surfaces. The cutout(s) are sufficiently large and sized to receive a plurality of surface segments. In these cutout(s), the surface segments can be fixed and aligned with respect to one another. If required, the outer surface can also be formed with a sliding surface in this area, such that the surface segments can move easily along the outer surface of the inner tool core, after they have been released, during removal from the mould.

Furthermore, an arrangement is also disclosed in which a flexible pressure element is provided, which can at least partially surround the at least one inner tool core. The at least one flexible pressure element preferably fixes the outer layer or stratum of the pre-prepared hollow-profiled component in a dimensionally accurate position during the curing process.

For the sake of completeness, it should be noted that the advantages and embodiment/variants described for the method equally apply to the arrangement. The arrangement is therefore particularly suitable for carrying out the method according to the invention.

These and still other advantages of the invention will be apparent from the detailed description and drawings. What follows is merely a description of some preferred embodiments of the present invention. To assess the full scope of the invention the claims should be looked to as the preferred embodiments are not intended to be the only embodiments within the scope of the claims.

### BRIEF DESCRIPTION OF THE DRAWINGS

FIG. 1 shows a cross section through a first arrangement for production of an integral hollow-profiled component according to the invention;

FIG. 2 shows one example of an integral hollow-profiled component which can be produced using the method according to the invention; and

FIG. 3 shows an aircraft having an aircraft component which can be produced using the method and the arrangement disclosed herein.

### DETAILED DESCRIPTION OF THE PREFERRED EMBODIMENT

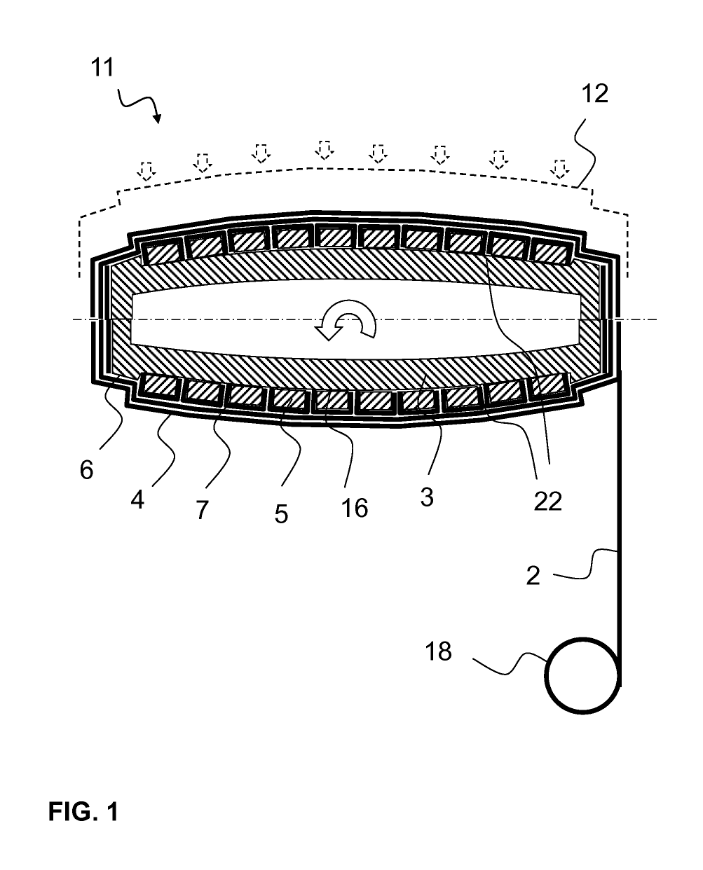

FIG. 1 shows a cross section through an arrangement 11 for production of integral hollow-profiled components. First of all, a reservoir 18 is provided at the bottom on the right in FIG. 1 for a fibre composite material 2 in the form of a strip such as, for example, an impregnator UD-CFC material. The fibre composite material 2 is arranged around an inner tool core 3 from this reservoir 18, preferably using robots or the like in an automated form for this process. The inner tool core 3 is designed in the form of a hollow profile and can rotate, as is indicated by the arrow shown in the centre of FIG. 1.

The integral inner tool core 3 has a cutout or holder 22 on its outer surface 6 and, in the particular embodiment illustrated, on opposite upper faces and lower faces of the inner tool core 3. A plurality of surface segment tools 5 in the form of strips are arranged in each of these holders 22. These surface segment tools 5 are arranged detachably (for example by screw connections) on the outer surface 6. Gaps are formed between the adjacent surface segment tools 5, into which parts of sections 7 of the fibre composite material 2 extend. For this purpose, the surface segment tools 5 are individually surrounded by separate sections in a U-shape, and are attached to the inner tool core 3. The holders 22 are preferably respectively formed on the upper face and on the lower face such that the surface segment tools 5 are laterally braced with respect to one another, and the adjacent sections 7 of the fibre composite material 2 accordingly rest on one another securely and with a predetermined pressure.

A tool prefabricated in this way with the (single) inner tool core 3 and the surface segment tool 5 provided with sections 7 of fibre composite material 2 on the outer surface 6 of the inner tool core 3 are now jointly provided with a plurality of layers 4 of fibre composite material. A winding process is preferably carried out in this case, using the so-called AFP process. Any desired number of layers of fibre composite material can therefore be positioned integrally, without any interruption, around the inner tool core and the surface segment tools 5. When a desired layer thickness or material thickness has been achieved, the fibre composite material 2 is interrupted towards the reservoir 18 and, if required, a flexible pressure element 12 is arranged on the outside around the inner tool core with the fibre composite material 2. The fibre composite material 2 is then cured at a considerably higher pressure than atmospheric pressure and at increased temperatures, for example at about 180° C. While the temperature is being increased in this way, it is possible by appropriately widening the inner tool core to deliberately create pressure towards the outer flexible pressure element 12, thus also resulting in internal dimensional compliance for the hollow-profiled component. During cooling down to room temperature, the inner tool core 3 shrinks, as a result of which the contact forces towards the solidified hollow-profiled component are small, and the inner tool core 3 can be removed easily, for example by a translational movement of the inner tool core 3.

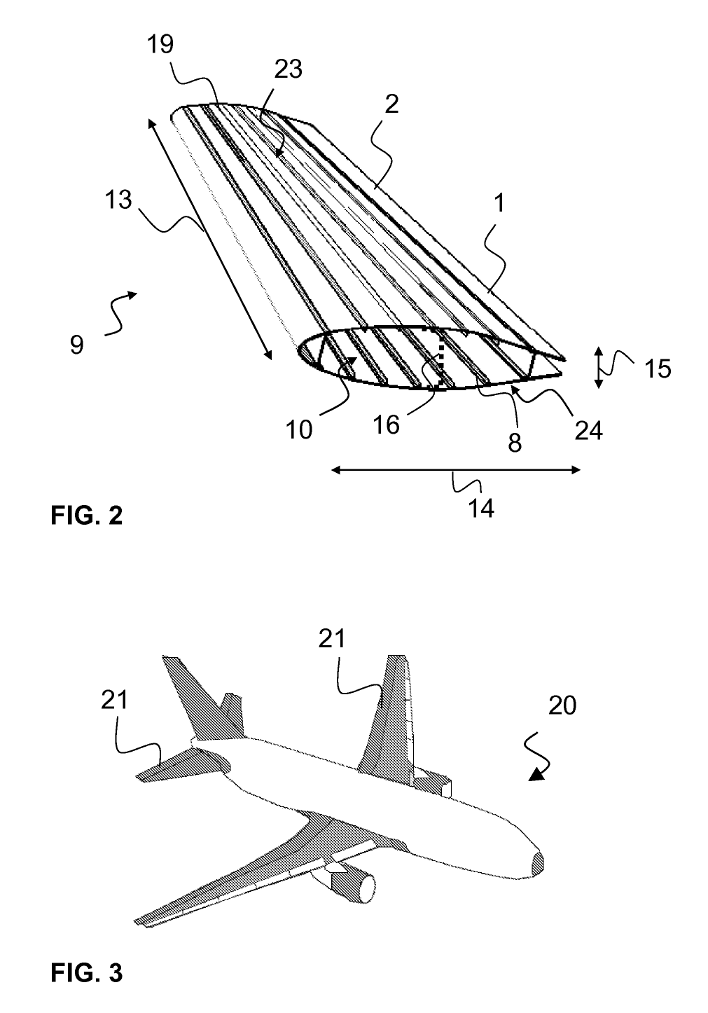

FIG. 2 shows a hollow-profiled component produced using this method in the form of an aircraft component 9, specifically in the form of a vertical tailplane. An aircraft component such as this is, for example, a component having a length 13 of about 6 m, a width 14 of about 2 m and a height 15 of about 0.8 m. It is therefore clear that dimensional compliance is particularly important for such large or large-volume components, and this can also be achieved for the first time for the internal area in a manner which is automated and with a reliable process. In particular, it is possible in this case to manufacture the aircraft component 9 with an outer skin 19 close to the final contours and with a predetermined internal cross section 10, which, if required, tapers in the direction of the length 13. Despite the stringers 8 running in the direction of the length 13, the dimensional compliance is sufficient to allow, if required, ribs 16 to be integrated and fitted into the hollow-profiled component 1 between the top wall 23 and the bottom wall of the component 24 without additional correction measures. To do this, a rib 16 such as this can be inserted with an accurate fit into the hollow-profiled component, and can be adhesively bonded there.

FIG. 3 illustrates an aircraft 20 with various flow surfaces 21. These flow surfaces 21 may be, for example, in the form of a vertical tailplane, and may be manufactured as the hollow-profiled component 1 disclosed herein is manufactured and using the disclosed method.

A preferred embodiment of the invention has been described in considerable detail. Many modifications and variations to the preferred embodiment described will be apparent to a person of ordinary skill in the art. Therefore, the invention should not be limited to the embodiment described.

I claim:

1. A method for production of an integral hollow-profiled component with fibre composite material, the method comprising:
a) providing at least one inner tool core,
b) covering the at least one inner tool core with at least one layer of fibre composite material,
c) curing the at least one layer of fibre composite material, and
d) removing the at least one inner tool core.

2. The method according to claim 1, wherein, between steps a) and b), at least one surface segment tool is positioned on an outer surface of the at least one inner tool core.

3. The method according to claim 2, wherein the at least one surface segment tool is applied with a section of fibre composite material.

4. The method according claim 1, wherein step b) comprises a winding process.

5. The method according to claim 1, wherein stringers, which run parallel to one another and are aligned with respect to the at least one inner tool core, are formed with the at least one layer of fibre composite material.

6. The method according to claim 1, wherein, in step d), a translational relative movement is carried out between the at least one layer of fibre composite material and the at least one inner tool core.

7. The method according to claim 1, wherein at least before or during step c), pressure is applied externally to the at least one layer of fibre composite material.

8. The method according to claim 1, wherein, after step d), at least one rib is inserted, in which the rib extends across the cross section of the integral hollow-profiled component.

9. An aircraft component produced using a method according to claim 1, wherein the aircraft component has an integral hollow-profiled component with a tapering cross section and a plurality of longitudinally running stringers.

10. An arrangement for production of integral hollow-profiled components, the arrangement comprising at least one inner tool core in the form of a hollow body with an outer surface and a plurality of surface segment tools which can be arranged on the outer surface.

11. The arrangement according to claim 10, in which a flexible pressure element is provided and can at least partially surround the at least one inner tool core.
